(19) United States
(12) Patent Application Publication
(10) Pub. No.: US 2021/0126261 A1
(43) Pub. Date: Apr. 29, 2021

(54) BIPOLAR ZINC ION BATTERY

(71) Applicant: Bangtaihongtu (Shenzhen) Technology Co., Ltd., Shenzhen (CN)

(72) Inventor: Yuying Yu, Shenzhen (CN)

(21) Appl. No.: 16/775,356

(22) Filed: Jan. 29, 2020

(30) Foreign Application Priority Data
Oct. 24, 2019 (CN) 201911018868.3

(51) Int. Cl. H01M 4/66; H01M 10/36; H01M 4/42; H01M 4/36; H01M 4/50

(52) U.S. Cl. CPC H01M 4/668; H01M 10/36; H01M 4/42; H01M 2004/029; H01M 4/50; H01M 4/667; H01M 2300/0002; H01M 4/366

(57) ABSTRACT

The invention discloses a bipolar zinc ion battery, which includes at least one unit group, wherein the unit group includes at least one battery unit, and the battery unit includes an anode plastic current collector layer, an isolating film and a cathode plastic current collector layer sequentially laminated and mutually adhered and sealed on a periphery, a cathode active material layer arranged inside a cathode plastic current collector and acted as a cathode, an anode active material layer arranged inside the anode plastic current collector layer and acted as an anode, an electrolyte solution soaked in gaps among the cathode, the anode and the isolating film and containing a zinc compound, and a porous ion channel arranged on the isolating film between the cathode and the anode for zinc ions to move on. The invention has a simple structure, a light weight, and very good safety performance and use performance.

### CROSS-REFERENCE TO RELATED APPLICATIONS

This non-provisional application claims priority under 35 U.S.C. § 119(a) on Patent Application No(s). 201911018868.3 filed in China on Oct. 24, 2019, the entire contents of which are hereby incorporated by reference.

### TECHNICAL FIELD

The present invention relates to a battery, and more particularly, to a bipolar zinc ion battery of a plastic current collector.

### BACKGROUND ART

The large-scale application of fossil fuels gave birth to the great prosperity of the whole 20^{th}-21^{st} century, but it also led to excessive emissions of greenhouse gases, and then led to global warming. New energy is developed based on this background. The large-scale development and application of wind energy and solar energy further reduce the price of new energy, and there is no cost barrier for large-scale promotion. However, the instability of output thereof has an impact on a power grid and also leads to many events of abandoning the wind energy and the solar energy. Unstable new energy requires an energy stabilizer and an energy mixer, and a battery is the most ideal energy stabilizer and mixer.

However, a conventional lithium ion battery has high costs and requires a lot of redundancy in safety management. Therefore, a safer battery technology with lower costs must be found for large-scale energy storage.

A conventional zinc-manganese battery uses MnO₂ as an anode, zinc metal as a cathode, and an aqueous solution as an electrolyte solution, so that it may have lower costs and be safe. However, the conventional zinc-manganese battery is acted as a primary battery and cannot be charged, or has a very low charging efficiency.

The conventional zinc-manganese battery uses a zinc foil or a stainless steel mesh as a current collector, and then a cathode and a cathode are connected in parallel, and an anode and an anode are connected in parallel to form the battery. The design is relatively traditional, and since the stainless steel mesh is used as the current collector, the battery has higher resistance and lower power, and steel mesh burrs and other phenomena are easy to occur, thus requiring thicker diaphragm paper to match.

Therefore, how to provide a chargeable and dischargeable and safe battery technology with a simple structure, a simple process and low costs is a technical problem to be solved urgently in the energy storage industry.

### SUMMARY OF THE INVENTION

In order to solve the technical problems above in the prior art, the present invention provides a bipolar zinc ion battery.

Stacking of a plurality of individual electrochemical batteries is used in the bipolar battery provided by the present invention, wherein a bipolar plate is connected with the electrochemical battery in series. Generally, each bipolar plate has a positive electrode material on a first side of the bipolar plate and a negative electrode material on a second side of the bipolar plate. Thus, when the bipolar plate separates two adjacent electrochemical batteries, the bipolar plate is used as a negative current collector plate of one electrochemical battery and a positive current collector plate of the second electrochemical battery. The bipolar plate allows a current to flow between adjacent electrochemical batteries during charging and discharging, and also provides electrochemical isolation between the electrochemical batteries, so that ions cannot flow between adjacent electrochemical batteries through the bipolar plate. Compared with a traditional unipolar battery unit (wherein a metal joint is used to connect current collector plates of the battery unit connected in series), electrons travel a very short distance on the bipolar plate, rather than traveling outside the unit through the metal joint, which can lead to more uniform current density and higher power design.

In design of a traditional bipolar battery, since a cathode and an anode share a same metal current collector, the battery is difficult to be sealed when stacked together and is also difficult to adapt to expansion problems of a battery material and a battery unit, and a problem or a defect existing in each layer is difficult to be detected.

A bipolar zinc ion battery provided by the present invention includes at least one unit group, wherein the unit group includes at least one battery unit, and the battery unit includes an anode plastic current collector layer, an isolating film and a cathode plastic current collector sequentially laminated and mutually adhered and sealed on a periphery to form two cavities, a cathode active material layer arranged inside the cathode plastic current collector and acted as a cathode, an anode active material layer arranged inside the anode plastic current collector layer and acted as an anode, an electrolyte solution soaked in gaps among the cathode, the anode and the isolating film and containing a zinc compound, and a porous ion channel arranged on the isolating film between the cathode and the anode for zinc ions to move on.

Specifically, the inside of the anode plastic current collector layer is coated with an anode material layer or a composite zinc foil layer containing zinc powder and acted as an anode.

Preferably, a surface of the zinc foil layer or a surface of each particle of the zinc powder is coated with an organic substance coating layer or an inorganic substance coating layer, or a coating layer mixed with organic and inorganic substances.

Preferably, the cathode active material contains a nano manganous manganic oxide particle, and/or the cathode active material is doped with Ni, Co, Al, Mg, Fe, V or Cu, and a surface of the manganous manganic oxide particle is coated with a carbon nanotube layer, a carbon layer or a graphene layer.

Specifically, the isolating film includes a porous channel region containing the porous ion channel arranged at a middle portion, and a frame region located around the porous channel region, an area of the porous channel region is larger than that of the anode and the cathode, so that a periphery of the porous channel region exceeds a periphery of the cathode and a periphery of the anode opposite to the porous channel region, and an area of the isolating film is larger than that of the anode plastic current collector layer and the cathode plastic current collector layer, so that a periphery of the frame region is exposed to the anode plastic current collector layer and the cathode plastic current collector layer after being adhered with the anode plastic current collector layer and the cathode plastic current collector layer.

Preferably, the isolating film layer is made of a porous base material, and the frame region is made of a polymer filled with the porous base material.

Preferably, the anode plastic current collector layer and the cathode plastic current collector layer are coated with conductive precoating layers respectively used for adhering anode and cathode electrode layers.

Specifically, when the unit group includes two or more battery units, the anode plastic current collector layer and the cathode plastic current collector layer of the adjacent battery units are mutually attached and connected in series.

Specifically, when the bipolar zinc ion battery includes two or more unit groups, the unit groups are laminated along a laminating direction of the battery units, an insulating layer is arranged between adjacent unit groups, and all the unit groups are connected in parallel through a current collector.

Specifically, a periphery of the bipolar zinc ion battery is provided with an outer metal hoop layer for preventing the bipolar zinc ion battery from expanding along the laminating direction of the unit groups, and a part of the outer metal hoop layer contacted with the unit groups is provided with the insulating layer.

The zinc ion battery provided by the present invention has simple process and structure and low costs, and can be well sealed, and using a gel electrolyte of an aqueous solution can play a role in preventing leakage. Moreover, the present invention does not use all metal as the current collector, so that a product is lighter in mass.

### BRIEF DESCRIPTION OF THE DRAWINGS

The present invention is described in detail hereinafter with reference to the embodiments and the drawings.

FIG. 1 is a structure diagram of a first embodiment of a battery unit of the present invention.

FIG. 2 is a structure diagram of a second embodiment of the battery unit of the present invention.

FIG. 3 is a structure diagram of a particle of zinc powder of the present invention.

FIG. 4 is a structure diagram of a manganous manganic oxide particle of the present invention.

FIG. 5 is a diagram of a laminated structure of first battery units of the present invention.

FIG. 6 is a diagram of a laminated structure of second battery units of the present invention.

FIG. 7 is a diagram of a laminated structure of unit groups of the present invention.

FIG. 8 is a partial size view of the battery unit of the present invention.

### DETAILED DESCRIPTION OF THE PREFERRED EMBODIMENTS

The principles and the embodiments of the present invention are described in detail hereinafter with reference to the drawings.

A bipolar zinc ion battery provided by the present invention includes at least one unit group. Each unit group includes at least one battery unit.

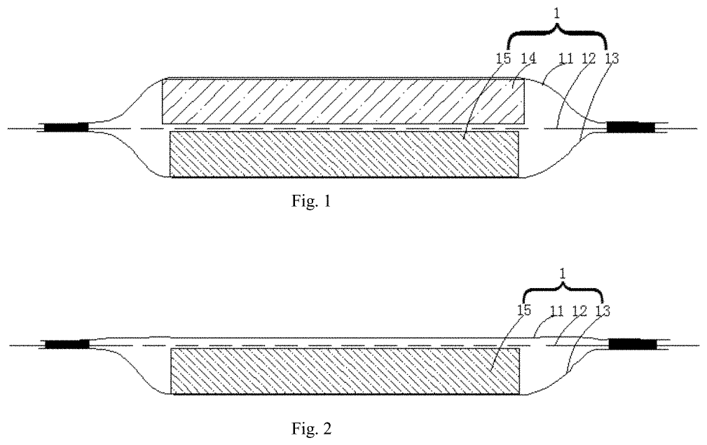

The battery unit 1 of the present invention may have two structures, and FIG. 1 and FIG. 2 show two embodiments of the battery unit of the present invention respectively.

As shown in FIG. 1, in the first embodiment, the battery unit 1 of the present invention includes an anode plastic current collector layer 11, an isolating film layer 12, a cathode plastic current collector layer 13, a cathode 15, an anode 14 and an electrolyte (not shown). The anode plastic current collector layer, the isolating film layer and the cathode plastic current collector layer are all made of flexible materials. For example, the anode plastic current collector layer 11 and the cathode plastic current collector layer 13 are made of plastic thin films made of PP, PE, PU, PIB or PET and a conductive agent, conductive thin films formed by mixing polypropylene PP, polyethylene PE, polyurethane PU, polyisobutene PIB, polyethylene terephthalate PET and carbon black, conductive thin films formed using a carbon nano tube CNT, or plastic thin films containing the carbon black or the carbon nano tube and electroplated with one or more metals such as Cu, Ni, Ti, Al, Fe, Cr, etc. Thin films of the anode plastic current collector layer 11 and the cathode plastic current collector layer 13 can be formed by extrusion, stretching, tape casting or rotary cutting, and can also be called a polymer current collector layer (PCC). The PCC has a resistivity of about 10⁻⁵ Ohm·m to 1 Ohm·m and a thickness of about 10 um to 100 um, and O₂ and H₂ are selectively permeable, while H₂O is impermeable. A region where the anode plastic current collector layer 11 and the cathode plastic current collector layer 13 are used to coat or adhere the anode and the cathode can be further provided with an electrode conductive precoating layer, the electrode conductive coating has a thickness of 2 um to 5 um and a resistivity of about 10⁻³ Ohm·m to 1 Ohm·m, and can be made of a conductive agent or other low-temperature activated adhesives mixed with PTFE, PM or PVDF, CMC and carbon black, graphene or a carbon nano tube. The isolating film layer uses PP, PET, PE, PI or other polymer materials as a base material, which is a porous film, with a pore diameter of 10 nm to 2000 nm and a porosity of 20% to 90%. A surface of the base material is processed by a plasma or chemical method to form more —OH, which will enable the isolating film layer to have a better water wetting ability, a better water absorption ability and a better liquid retention ability. A center of the base material is a porous channel region for zinc ions to move on, one face of the porous channel region of the base material is coated with ceramic (such as Al₂O₃, Al₂O₃—H₂O, TiO₂, etc.) and an adhesive to inhibit a zinc metal dendrite and enhance an adhesive force, and the other face of the base material is coated with an adhesive (SBR, PVDF, PTFE, PM, etc.) to enhance an adhesive force. Both faces of a frame region located around the porous channel region are coated with an adhesive to adhere the anode plastic current collector layer 11 and the cathode plastic current collector layer 13 to seal the battery. The frame region may be made of a porous base material filled with a polymer to fill a pore, and the frame region may also be directly subjected to pore closing by hot pressing.

Then, the anode plastic current collector layer 11, the isolating film layer 12 and the cathode plastic current collector layer 13 are sequentially laminated, the two cavities are formed by mutually adhering and sealing the periphery through the adhesives on the two faces of the frame region of the isolating film layer 12, and the anode and the cathode are respectively arranged in the two cavities, wherein the cathode is composed of a cathode active material layer arranged inside the cathode plastic current collector layer, and the anode is composed of an anode material layer or a zinc foil layer containing zinc powder and coated inside the anode plastic current collector layer 11. An electrolyte solution containing an electrolyte is uniformly distributed in pores of the isolating film, the cathode and the anode, the electrolyte contains a zinc compound, and the porous channel region is provided with a plurality of pores for zinc ions to move in. The zinc ions can move between the cathode and the anode through the pores during charging and discharging.

Since The anode plastic current collector layer and the cathode plastic current collector layer are made of plastic materials, a smooth curved surface is formed between an electrode attachment region (anode or cathode) and a sealed edge, as shown at a position A in FIG. 8, and a position B in FIG. 8 is a sealed region of the anode plastic current collector layer, the cathode plastic current collector layer and the isolating film layer. A distance from a left edge of the sealed region to an edge of the anode plastic current collector layer or the cathode plastic current collector layer is less than 0.1 mm, a distance from a right edge of the sealed region to an edge of the anode plastic current collector layer or the cathode plastic current collector layer is more than 1 mm, and an edge of the isolating film layer is 0.1 mm larger than an edge of the anode plastic current collector layer or the cathode plastic current collector layer. In the embodiment, an edge of the anode is 0.1 mm and below larger than an edge of the cathode.

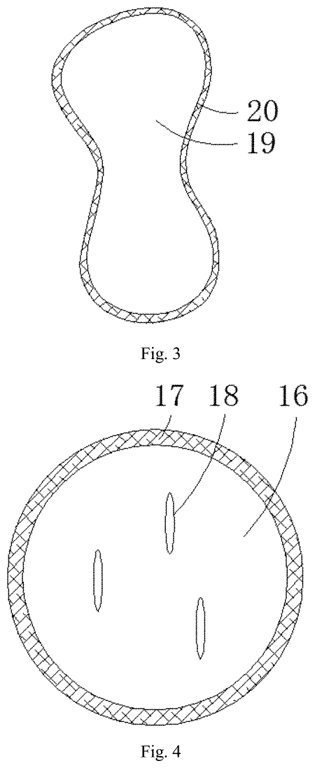

As shown in FIG. 3, a surface of a particle 19 of the zinc powder can be processed to form a coating layer 20, and a surface stability can be improved and dendrite formation during charging and discharging can be inhibited by coating an inorganic coating. Specifically, the surface of the particle of the zinc powder can be coated with Al₂O₃, SiO₂, TiO₂, CaO, MgO, ZnO, ZnF2, ZnCl₂ and ZnCO₃, and the surface stability can further be improved and dendrite growth can be inhibited by coating an organic coating. Specifically, a surface of a Zn particle or a zinc foil can be coated with PA (CA (citric acid), PEGPE, PEO, etc.). Certainly, the surface can also be coated with a coating layer of an organic and inorganic mixture, such as a ZnO mixture of PA or CA. In a specific embodiment, we use zinc alloy as an anode material, and using zinc alloy with Bi, Sn, Cu and In elements as an anode material will be beneficial for inhibiting release of O₂ and H₂. A specific formula of the anode material may be 95% zinc powder, 4% PVDF and 1% carbon nano tube; 96% zinc powder, 2% CMC, 2% SBR and 1% carbon nano tube; 96% zinc powder, 3% PTFE and 1% carbon nano tube; or 95% zinc powder, 3% PIB, 1% graphite and 1% carbon nano tube.

As shown in FIG. 4, a cathode active material contains a manganous manganic oxide particle 16, and/or the cathode active material is doped with a doping particle 18 such as Ni, Co, Al, Mg, Fe, V or Cu. The manganous manganic oxide particle 16 has a size of about 10 nm to 20 um, and we can process a surface thereof to improve an electronic conductivity. Specifically, the surface of the manganous manganic oxide particle can be coated with a carbon nano tube layer, a carbon layer or a graphene layer. These coating layers 17 have a thickness of 0.1 nm to 1 nm and form a three-dimensional network structure, which may be a coating layer made by a physical or chemical method. Another method for processing the surface is also to improve the surface stability, we can coat with Al₂O₃ and MgO, and the manganous manganic oxide can be mixed with a dopant, such as Ni, Co, Al, Mg, Fe, V or Cu, and a doping proportion can be a mixture of one or more listed materials within 10%, so as to improve a stability of a structure. A formula of the cathode material layer may be 95% manganous manganic oxide, 4% PVDF and 1% carbon nano tube; 96% manganous manganic oxide, 2% CMC, 2% SBR and 1% carbon nano tube; 96% manganous manganic oxide, 3% PTFE and 1% carbon nano tube; or 95% manganous manganic oxide, 3% PIB, 1% graphite and 1% CNT.

The electrolyte solution of the present invention uses a mixture (C2F6O6S2Zn) ZnBOB of ZnSO4, MnSO4 and zinc methanesulfonate as the electrolyte and purified water as a solvent, a PH value is controlled between 6 and 8, a Zn ion concentration ranges from 0.5 mol/L to 10 mol/L, a Mn ion concentration ranges from 0.1 mol/L and 10 mol/L, and a copolymer of CMC, PEO or VDF is used as the gel material. Further, an electrolyte additive such as VC, FEC or an additive reduced at a low voltage can be used to improve a cycle life of a battery, and since an aqueous solution is used as the electrolyte solution, the zinc ion battery of the present invention has a very good fireproof effect.

As shown in FIG. 2, in the second embodiment, a battery unit of the present invention includes an anode plastic current collector layer 11, an isolating film layer 12, a cathode plastic current collector layer 13, a cathode 15 and an electrolyte (not shown). In the embodiment, the anode plastic current collector layer 11 is acted as an anode without a zinc precoating layer, and the electrolyte will deposit zinc on the anode plastic current collector layer 11 during first charging to form the anode. Other structures such as the isolating film layer, the electrolyte, the cathode, etc. are the same as those of the first embodiment. In the embodiment, a sufficient void space exists during overcharging or overdischarging for gas accumulation, and both heat sealing and an adhesive can select a permeability, allowing release of H₂ and O₂, but H₂O is not allowed to be permeated out, or a one-way valve capable of releasing a pressure is arranged on a sealed region of a battery, so that when an internal pressure is accumulated to a certain pressure, the pressure is released (for example, the pressure is 0.01 Mpa to 0.05 Mpa higher than an atmospheric pressure). A periphery of the same isolating film layer is wider than a periphery of the anode plastic current collector layer 11 and a periphery of the cathode plastic current collector layer 13, a total thickness range of one battery unit is about 100 um to 5000 um, and a ratio of a length or a width to a thickness of the battery unit is about 10 to 10⁶. In the drawing, an up-down direction from the anode plastic current collector layer 11 and the cathode plastic current collector layer 13 is a thickness direction. A width of a frame region of the isolating film layer 12 is larger than that of a sealed place, and a penetration area of a porous channel region is larger than an area of the cathode.

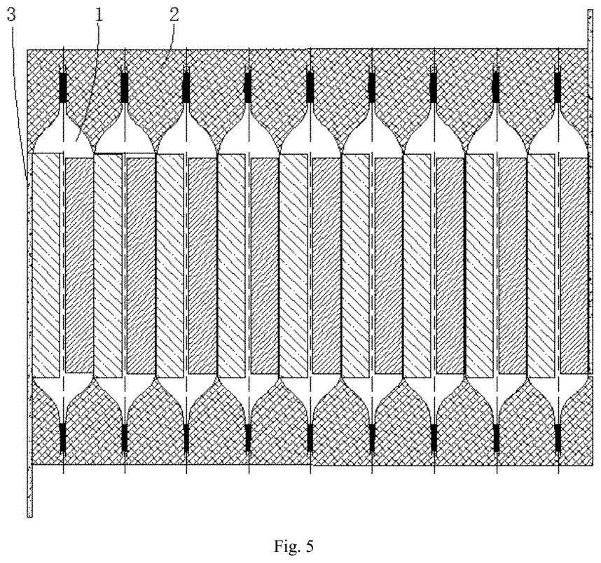

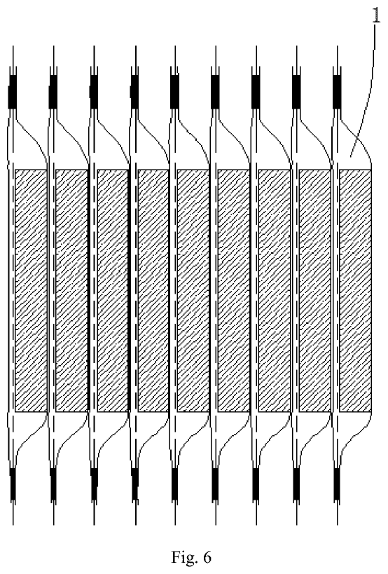

As shown in FIG. 5 and FIG. 6, a plurality of battery units 1 are laminated in a same direction, that is, the anode plastic current collector layer 11 and the cathode plastic current collector layer 13 of adjacent battery units are mutually adhered and connected in series, so that the series connection between the battery units 1 will form a unit group. Gaps around a periphery between the battery units 1 are filled with an insulating layer 2 (the insulating layer is not shown in FIG. 6), the insulating layer 2 is filled at an edge between the battery units to isolate stacked high-voltage batteries, and a material used in the insulating layer may be a polymer with a high expansion rate, namely, an elasticity, which can compensate expansion of the battery unit, such as a rubber polymer, EPDM and silicone rubber.

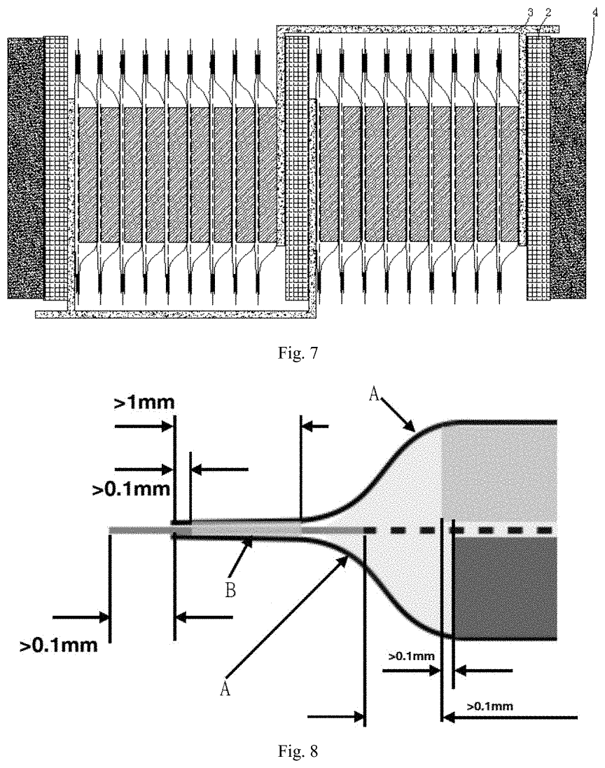

As shown in FIG. 7, when a plurality of unit groups are stacked, that is, when the bipolar zinc ion battery includes two or more unit groups, the unit groups are laminated along a laminating direction of the battery units 1, and the insulating layer 2 is arranged between adjacent unit groups, and the unit groups are connected in parallel through a current collector 3. A specific assembly structure of the unit groups in FIG. 6 is similar to that in FIG. 5, and the insulating layer at the gaps around the periphery of the unit groups is not shown. A periphery of the insulating layer 2 in the laminating direction is also provided with a stainless steel frame 4 to prevent the battery from expanding along the laminating direction of the unit groups, and the insulating layer in the laminating direction needs to absorb expansion of the unit groups while avoiding short circuit. The insulating layer may be EPDM rubber, PE, PBT, PET, PP, PVC, etc., and a plastic current collector may be doped or electroplated with copper, aluminum, nickel or carbon nano tube composite materials or any combination of the materials above. 2 to 1000 single-layer battery units can be stacked in one unit group, and a voltage of the unit group may be as high as 2000 V.

A method for manufacturing the battery unit is described below.

Cathode powder, a conductive agent and an adhesive are made into thin sheets by double helix extrusion forming, a density is increased by rolling, and the thin sheets are attached to the plastic current collector by thermal compounding to form a cathode piece; and similarly, an anode piece is made in the same way. Then, the cathode piece, the diaphragm paper and the anode piece are compounded by laminating, an electrolyte solution is sprayed during laminating, and sealing is performed at the frame region, and finally the battery unit is formed. The battery units are laminated to form a battery group.

Those described above are merely preferred embodiments of the present invention, but are not intended to limit the present invention. Any modifications, equivalent substitutions and improvements made without departing from the spirit and principle of the present invention shall all fall within the protection scope of the present invention.

1. A bipolar zinc ion battery, comprising at least one unit group, wherein the unit group comprises at least one battery unit, and the battery unit comprises an anode plastic current collector layer, an isolating film and a cathode plastic current collector layer sequentially laminated and mutually adhered and sealed on a periphery, a cathode active material layer arranged inside a cathode plastic current collector and acted as a cathode, an anode active material layer arranged inside the anode plastic current collector layer and acted as an anode, an electrolyte solution soaked in gaps among the cathode, the anode and the isolating film and containing a zinc compound, and a porous ion channel arranged on the isolating film between the cathode and the anode for zinc ions to move on.

2. The bipolar zinc ion battery according to claim 1, wherein the inside of the anode plastic current collector layer is coated or electroplated with an anode material layer or a zinc foil layer containing zinc powder or zinc alloy and acted as an anode.

3. The bipolar zinc ion battery according to claim 2, wherein a surface of the zinc foil layer or a surface of each particle of the zinc powder is coated with an organic substance coating layer or an inorganic substance coating layer, or a coating layer mixed with organic and inorganic substances.

4. The bipolar zinc ion battery according to claim 1, wherein the cathode active material contains a nano manganous manganic oxide particle, and/or the cathode active material is doped with Ni, Co, Al, Mg, Fe, V or Cu, a surface of the manganous manganic oxide particle is coated with a carbon nanotube layer, a carbon layer or a graphene layer, and the carbon layer, the carbon nanotube layer or the graphene layer forms a three-dimensional network structure to connect all nano manganous manganic oxide particles.

5. The bipolar zinc ion battery according to claim 1, wherein the isolating film comprises a porous channel region containing the porous ion channel arranged at a middle portion, and a frame region located around the porous channel region, an area of the porous channel region is larger than that of the anode and the cathode, so that a periphery of the porous channel region exceeds a periphery of the cathode and a periphery of the anode opposite to the porous channel region, and an area of the isolating film is larger than that of the anode plastic current collector layer and the cathode plastic current collector layer, so that a periphery of the frame region is exposed to the anode plastic current collector layer and the cathode plastic current collector layer after being adhered with the anode plastic current collector layer and the cathode plastic current collector layer.

6. The bipolar zinc ion battery according to claim 5, wherein the isolating film is made of a porous base material, and the frame region is made of a polymer filled with the porous base material or formed by closing the original porous channel region through heat treatment.

7. The bipolar zinc ion battery according to claim 2, wherein the anode plastic current collector layer and the cathode plastic current collector layer are coated with conductive precoating layers respectively used for adhering an anode material and a cathode material.

8. The bipolar zinc ion battery according to claim 1, wherein when the unit group comprises two or more battery units, the anode plastic current collector layer and the cathode plastic current collector layer of the adjacent battery units are mutually attached and connected in series.

9. The bipolar zinc ion battery according to claim 1, wherein when the bipolar zinc ion battery comprises two or more unit groups, the unit groups are laminated along a laminating direction of the battery units, an insulating layer is arranged between adjacent unit groups, and all the unit groups are connected in parallel through a current collector.

10. The bipolar zinc ion battery according to claim 9, wherein a periphery of the bipolar zinc ion battery is provided with an outer metal hoop layer for preventing the bipolar zinc ion battery from expanding along the laminating direction of the unit groups, and a part of the outer metal hoop layer contacted with the unit groups is provided with the insulating layer.
